(19) United States
(12) Patent Application Publication
(10) Pub. No.: US 2008/0199581 A1
(43) Pub. Date: Aug. 21, 2008

(54) PROCESSS FOR SACCRIFICATION AND LIQUIFICATION OF POTATO AND TAPIOCA

(76) Inventors: Peter Kriss, Buckhorn (CA); Robert Somers, Vancouver (CA); Ian Toews, Vancouver (CA)

Correspondence Address: VERMETTE & CO., SUITE 320 - 1177 WEST HASTINGS STREET, VANCOUVER, BC, V6E2K3, omitted

(21) Appl. No.: 11/677,165

(22) Filed: Feb. 21, 2007

(51) Int. Cl. A23L 1/2165; A23L 1/214; A23L 1/48; A23L 1/216

(52) U.S. Cl. 426/464; 426/442; 426/456; 426/519

(57) ABSTRACT

A method of preparing a food concentrate material, by the following steps: forming a slurry of water, dehydrated potatoes and whole grain tapioca flour; adjusting the pH of the slurry to a neutral value; heating the slurry; performing particle reduction of the slurry; steam heating the slurry to destroy viable bacteria and enhance starch formation; flashing residual steam and volatile constituents from the slurry; cooling the slurry; incubating the slurry with cellulase, bacterial amylase, and fungal amylase; and, heating the slurry to degrade the enzymes. The resultant hydrated concentrate can be used directly for human consumption or dried and ground into a powdered concentrate

### FIELD

The present invention relates to a process for saccrification of dehydrated potatoes and whole grain tapioca flour and the preparation of liquid and/or dry concentrates composed of the two ingredients.

### BACKGROUND

Lactose intolerance is a condition in which the body is not able to easily digest foods that contain lactose or the natural sugar found in dairy products. Lactose intolerance is caused by a genetic shortage of lactase enzymes that break down lactose into glucose and galactose. The inability to digest lactose causes symptoms such as gas, bloating, stomach cramps diarrhea, headaches, and nausea An estimated 30% to 50% of all Americans have lactose intolerance while 70% of African-Americans, 74% of native Americans and 90% of Asian American adults are affected., World-wide, obviously Asians are largely lactose intolerant.

A second problem with dairy foods is milk allergies which are caused when the immune system reacts with the proteins found in milk Such a problem occurs because the immune system fails to learn to recognize milk proteins as being harmless. Thus, when milk is ingested by someone allergic to milk, the proteins come in touch with the immune system, which, unfortunately, fails to recognize them and mistakes them as unwanted and harmful proteins An exaggerated reaction occurs which is termed hypersensitivity.

There has been considerable development activity to attempt to formulate non-dairy substitutes which simulate milk and other dairy foods For example, soy based products range from milk to egg replacement foods with many other types of dairy replacement foods Often the sugar content of such foods is relatively high and unsuitable for diabetics In addition, flavours found in soy materials often prevent their ready acceptance by the consumer. Although methods exist for removing flavour materials from soy, generally, there is a trade-off between loosing soy protein and removing flavour components In other cases the non-dairy product is made from the phosphoprotein, casein, the dominant protein of milk.

Consequently, there is a need for a non-dairy formulation that has low levels of sugar and complex carbohydrates, and yet is characterized by a pleasant flavour and acceptable nutritional value.

### SUMMARY OF THE INVENTION

According to the invention there is provided a method of preparing a food concentrate material, comprising forming a slurry of water, dehydrated potatoes and whole grain tapioca flour, adjusting the pH of the slurry to a neutral value in the range of about 6.8 to about 7.1, heating the slurry to approximately 110 degrees C., performing particle reduction of the material, heating the slurry sufficiently to destroy viable bacteria and enhance starch formation, and flashing residual steam and volatile constituents of the slurry. The material is then cooled to about 70 degrees C. and cellulase is added to degrade pectin. Approximately 15 minutes later bacterial amylase and fungal amylase are added for an additional incubation period of about 45 minutes, and the slurry is heated to about 132 degrees C. for approximately 23 seconds to degrade the enzymes

The final hydrated concentrate can be used directly for human consumption or, optionally, dried and ground into a powder concentrate.

In the preferred embodiment, the second heating step is performed by raising the temperature by steam injection to between about 140 degrees C. to about 145 degrees C.

### BRIEF DESCRIPTION OF THE DRAWING

FIG. 1 is a flow diagram of the preferred embodiment of the invention.

### DETAILED DESCRIPTION WITH REFERENCE TO THE DRAWING

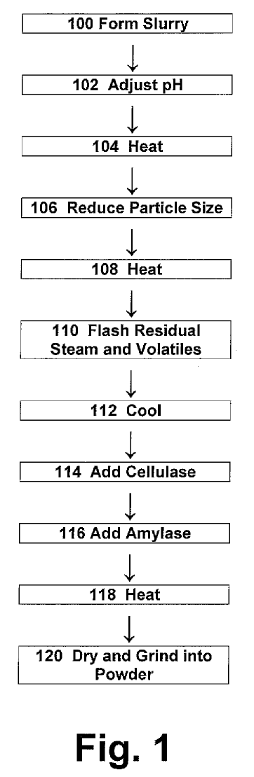

Referring to FIG. 1, the process of the invention for saccrification/liquification of dehydrated potatoes and whole grain tapioca flour and the preparation of liquid and/or dry concentrates composed of the two ingredients is shown. Initially, 100 a slurry is formed comprising water, tapioca flour and ground dehydrated potatoes. The ratio of dehydrated potatoes to tapioca flour is approximately 1:2.6. The total water content of the slurry, by weight, is approximately 32% The slurry is adjusted 102 to a neutral pH of about 6.8 to about 7.1 and then heated 104 to a temperature of about 110 degrees C. for a period of about 3 minutes At step 106 the size of the particulate matter is reduced, preferably by a 3-stage process of high speed agitation, followed by paddle or impeller mixing to facilitate feeding to the filtration unit, followed by filtration through a 228/1000 micro cut head. The slurry is then subjected to steam injection 108 to raise the temperature of the treated slurry sufficiently to destroy viable bacteria and to promote starch formation The preferred temperature range is from about 140 degrees C. to about 145 degrees C. This temperature is maintained for a short time period of time, preferably about 8 seconds. Residual steam and volatile contituents including objectionable flavour elements are flashed from the slurry 110 The steam-treated slurry is cooled 112 to about 70 degrees C. and cellulase is added 114 to break down pectin fibres Fifteen minutes later bacterial amylase and fungal amylase are added 116 and the slurry is incubated for 45 minutes. The slurry is then heated 118 to a temperature that is sufficient to deactivate the enzymes. About 132 degrees C. for 23 seconds is preferred.

The hydrated concentrate thus resulting can be used for human consumption or it can be dried, as by spray drying, and ground into a powder concentrate 120 in a humidity controlled environment to be finally used as a food ingredient for human consumption.

The finished dry or hydrated concentrates are composed of two ingredients: maltodextrin and starch, and have a high degree of solubility and a neutral flavour In the case of the liquid concentrate the brix level is in excess of 24 degrees. Similarly, the dry concentrate reconstituted in a slurry form is 24 brix. Each are substantially free of bacterial activity The process results in the absence of objectionable grit, undissolved solids, or further enzymatic activity. The concentrates are light in colour and suitable for use in food preparations for human consumption with enhanced palatability.

Accordingly while this invention has been described with reference to illustrative embodiments, this description is not intended to be construed in a limiting sense. Various modifications of the illustrative embodiment will be apparent to those skilled in the art upon reference to this description. It is therefore contemplated that appended claims will cover any such modifications or embodiments as fall within the scope of the invention.

I claim:

1. A method of preparing a food concentrate, said method comprising:
(a) forming a slurry of water, dehydrated potatoes, and whole grain tapioca flour;
(b) adjusting the pH of said slurry to a neutral value;
(c) heating the slurry;
(d) reducing the concentration of particles in the slurry;
(e) heating the slurry sufficiently to destroy viable bacteria and enhance starch formation;
(f) cooling the slurry;
(g) adding cellulase to the slurry;
(h) adding at least one amylase to the slurry; and
(i) heating the slurry.

2. The method of claim 1 wherein step (b) is performed by adjusting the pH to between about 6.8 and 7.1.

3. The method of claim 1 wherein step (c) is performed by heating the slurry to about 110 degrees C.

4. The method of claim 1 wherein step (d) is performed by at least one mechanical means

5. The method of claim 1 wherein step (d) comprises the steps of:
a. agitating the slurry at high speed;
b. mixing the slurry; and
c. filtering the slurry

6. The method of claim 1 wherein step (e) is performed by injecting steam into the slurry.

7. The method of claim 6 further comprising the step of flashing residual steam and volatile components from the slurry.

8. The method of claim 1 wherein step (e) is performed by raising the temperature of the slurry to between about 140 degrees C. and about 145 degrees C.

9. The method of claim 1 wherein the slurry is cooled to about 70 degrees C. at step (f)

10. The method of claim 1 wherein bacterial amylase is added at step (h)

11. The method of claim 1 wherein fungal amylase is added at step (h).

12. The method of claim 1 wherein step (i) is performed by heating the slurry to about 132 degrees C.

13. The method of claim 1 wherein step (i) is performed by heating the slurry for about 23 seconds.

14. The method of claim 1 further comprising the step of drying the slurry into a dry concentrate.

15. The method of claim 14 further comprising the step of grinding the dry concentrate into a powder

16. The method of claim 15 wherein the grinding is performed in a humidity controlled environment.
